(19) United States
(12) Patent Application Publication
(10) Pub. No.: US 2022/0288708 A1
(43) Pub. Date: Sep. 15, 2022

(54) WIRE SAW

(71) Applicant: Schwing GmbH, St. Stefan im Lavanttal (AT)

(72) Inventors: Markus Hatzer, Virgen (AT); Reinhold Gracner, Griffen (AT)

(21) Appl. No.: 17/635,103

(22) PCT Filed: Aug. 10, 2020
(86) PCT No.: PCT/EP2020/072353

§ 371 Date: Feb. 14, 2022

(30) Foreign Application Priority Data
Aug. 13, 2019 (AT) A 50713/2019

(51) Int. Cl. B23D 57/00; B28D 1/08

(52) U.S. Cl. CPC B23D 57/0053; B23D 57/0061; B23D 57/0069; B28D 1/088

(57) ABSTRACT

A wire saw includes a saw wire forming a sawing section for engagement with a workpiece to be cut. A guide is arranged to position the sawing section of the saw wire relative to the workpiece. The guide is configured to permit a plurality of independent directions of movement such that, in addition to an advance of the sawing section in the direction of the workpiece to be cut, the sawing section can be lengthened and/or shortened. A wire-storage-and-tensioning device is arranged for loading, unloading, and tensioning the saw wire when a position and/or a length of the sawing section is changed by the guide. The guide has, for each of the plurality of independent directions of movement, a separate wire storage associated with the given individual direction of movement.

The invention relates to a wire saw for cutting up a solid workpiece, such as concrete or stone blocks, comprising at least one saw wire driven by a drive, the saw wire forming a sawing section for engagement with the workpiece to be cut up, at least one guiding device for guiding the driven saw wire, the guiding device being arranged to position the sawing section of the driven saw wire relative to the workpiece, the guiding device permitting a plurality of independent directions of movement, so that, in addition to an advance of the sawing section in the direction of the workpiece to be cut, at least one lengthening or shortening of the formed sawing section is also possible, at least one wire storage and wire tensioning device for loading and unloading and tensioning the saw wire when the position and/or length of the sawing section is changed by the guiding device.

In such a wire saw, for cutting stone blocks, a saw wire studded with diamond segments is usually pulled through the workpiece at a speed of up to 40 m/s (144 km/h) to cut it.

In known stationary wire saws, such as those known from FR 596 906 A, an endless saw wire is usually guided over two deflection pulleys. On the one hand, it is disadvantageous that the workpieces to be cut cannot be cut on site, but must be transported to the wire saw. On the other hand, it is disadvantageous that the wire saw has a fixed and limited sawing section and cutting height due to the fixed distance between the two deflection pulleys and can only work on wire pressure, whereby the wire tension is usually not variable. Due to these disadvantages, the weight and size of the solid workpiece to be cut are also limited in these stationary wire saws.

In the case of mobile wire saws known, for example, from EP 1 086 794 A2, which are brought to the solid workpiece in order to cut it up, a disadvantage lies mainly in the fact that an open saw wire must be laid around the workpiece, which is then compressed into an endless saw wire. For this purpose, a hole must be drilled into the workpiece to allow the saw wire to pass through. A disadvantage is that the saw wire must be opened in order to pass through the workpiece. This is also disadvantageous because the saw wire cannot be guided precisely and thus an exact cut cannot be made. Since the saw wire is additionally guided around sharp edges, for example in the area of entry into the workpiece or in the area of exit from the workpiece, it is usually subject to increased wear and there is an increased risk of injury, since in the event of a wire break a relatively long section of the saw wire can lash out like a whip. Thus, a large safety zone must be established around the wire saw. Another disadvantage of such wire saws is the size of the guiding device, which restricts mobile use, since the dimensions of such a saw mounted ready for use do not permit long transport distances. For this reason, such wire saws often have to be assembled ready for use on site.

It is therefore the task of the invention to specify an improved wire saw which permits a compact transport size and fast and safe use, while additionally providing a high degree of flexibility in changing the position and/or length of the sawing section by means of the guiding device.

This task is solved by a wire saw with the features of claim 1.

By the fact that the guiding device for each of the directions of movement has a separate wire storage associated with the individual direction of movement, a compact size of the wire saw for transport can be achieved and nevertheless an accurate and safe guiding of a sufficiently large sawing section during the cutting of the workpiece can be realized. Via the wire storages assigned for each of the directions of movement, a compact design and a flexible change of the position and/or length of the sawing section can be realized by the guiding device, which furthermore makes the wire saw applicable both in tension and compression. With the separate assignment of the wire storage to the individual direction of movement, the sawing section of the saw wire can be flexibly adapted to the desired cutting shape, cutting length, cutting width and cutting height. With the wire storage assigned, the flexibly adaptable guiding device can be constructed very compactly, since a separate wire storage is provided for each direction of movement. This also makes it possible to reduce the size of the individual wire storages, which in the event of wire breaks shortens the length of the saw wire that is being sheared, so that the required safety area when cutting up the workpiece can be designed to be smaller.

Advantageous embodiments and further embodiments of the invention will be apparent from the dependent claims. It should be noted that the features listed individually in the claims can also be combined with one another in any desired and technologically useful manner, thus revealing further embodiments of the invention.

In accordance with an advantageous embodiment of the invention, it is provided that the guiding device has a wire storage formed from at least one pair of deflection pulleys for each of the directions of movement. With the formation of the associated wire storage from at least one pair of deflection pulleys, a particularly simple and compact structure of the guiding device is possible. The at least two deflection pulleys of a wire storage store the saw wire by deflecting it for the assigned direction of movement and release it when required for movement in the assigned direction the saw wire to the required extent.

Particularly preferred is an embodiment which provides that the deflection pulley pair of a wire storage stores or releases saw wire via an increase and decrease of the pulley distance of the deflection pulleys combined in pairs to form the wire storage when the position and/or length of the sawing section is changed. By increasing and decreasing the pulley distance, the wire storage can very easily store and release the saw wire to the required extent when the guiding device moves in the assigned direction. For this purpose, the change of the pulley distance is advantageously coupled to the movement of the guiding device in the assigned direction of movement. Via this coupling of the pulley distance to the individual direction of movement of the guiding device, the wire storage can be constructed very simply and compactly when the position and/or length of the sawing section is changed. The coupling of the pulley distance of the deflection pulleys to the movement of the guiding device in the assigned direction ensures that the saw wire is always stored or released to the extent dependent on the movement.

A particularly advantageous embodiment of the invention relates to the fact that the pulley distance of the deflection pulleys combined in pairs to form the wire storage can be changed via telescopic extensions on which at least one deflection pulley is arranged. Via telescopic extensions, the distance of the deflection pulleys combined in pairs can be easily changed in order to adapt the storage capacity of the wire storages to the change in position and/or length of the sawing section made by the guiding device. Via the change in distance of the deflection pulleys by the telescopic extensions, a coupling with a movement in the associated direction of movement can very easily be made, in that the telescopic extensions are coupled to the guiding device and can be telescoped when the guiding device moves in the direction of movement associated with the wire storage.

A particularly advantageous embodiment of the invention provides that the pulley distance of the deflection pulleys combined in pairs to form the wire storage can be changed via telescopic extensions on which both deflection pulleys are arranged. In this case, the deflection pulleys are preferably arranged on a double telescopic extension which can advantageously displace the two deflection pulleys combined in pairs to form the wire storage in opposite directions in order to change the distance of the two deflection pulleys from each other and the position relative to each other and absolutely to the workpiece. This provides a guiding device which is particularly flexible in changing the position and/or the length of the sawing section of the wire saw.

An advantageous embodiment of the invention provides that the guiding device has two main telescopic extensions via which the sawing section is fed in the direction of the workpiece to be cut. With the two main telescopic extensions, a particularly simple change of the position of the sawing section by the guiding device is possible. The two main telescopic extensions advantageously allow a jointly coordinated feed of the sawing section in the direction of the workpiece to be cut, but also an independent feed of the sawing section in the direction of the workpiece to be cut. This enables particularly flexible positioning of the sawing section relative to the workpiece to be cut.

Particularly advantageous is an embodiment which provides that the main telescopic extensions have deflection pulleys combined in pairs to form the wire storage, the extension position of which can be changed on both sides via the main telescopic extensions for feeding the sawing section in the direction of the workpiece to be cut. With the change of the pull-out position of the deflection pulleys arranged on the main telescopic extensions, a particularly simple feed of the sawing section in the direction of the workpiece to be cut is possible.

An advantageous embodiment provides that the main telescopic extensions of the guiding device can be changed in their distance from each other in order to change the length of the sawing section. By changing the distance of the two main telescopic extensions relative to each other, the length of the sawing section can be varied in a very simple manner by displacing the main telescopic extensions in each case in one direction of movement of the guiding device. An outward displacement on both sides increases the distance between the main telescopic extensions and thus the length of the available sawing section, while an inward displacement on both sides reduces the distance between the main telescopic extensions and thus the length of the available sawing section. This allows the wire saw guide assembly to be quickly adjusted from a compact transport configuration to an enlarged saw configuration.

According to a preferred embodiment of the invention, it is provided that the main telescopic extensions are movable independently of each other. With independent movement of the two main telescopic extensions relative to each other and absolutely to the workpiece, the guiding device can be flexibly adjusted and the position and/or length of the sawing section can be easily changed.

Further features, details and advantages of the invention will become apparent on the basis of the following description and with reference to the drawings, which show embodiments of the invention. Corresponding objects or elements are provided with the same reference signs in all figures. Showing:

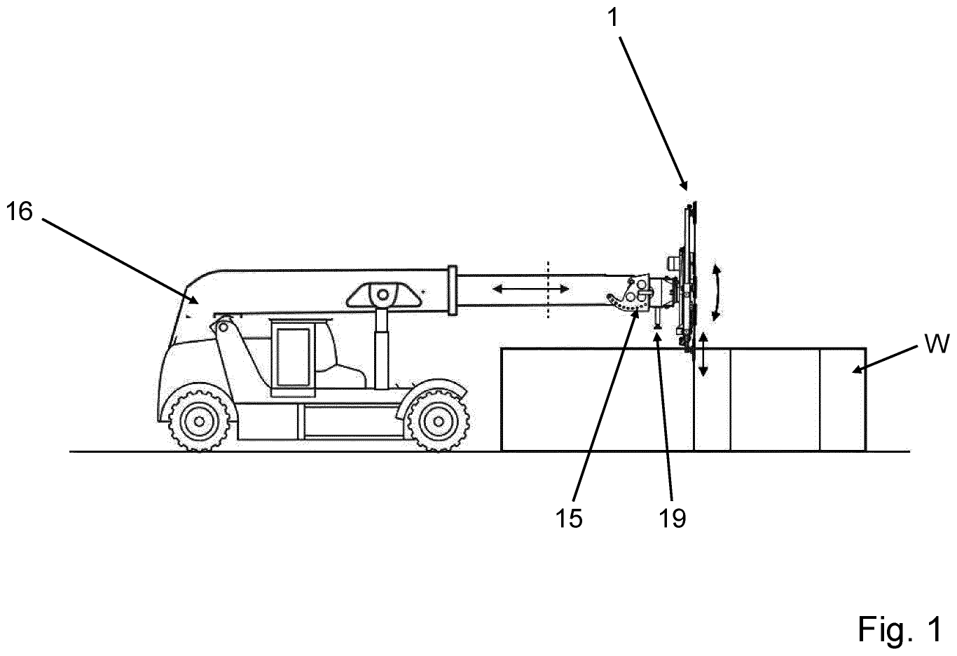

FIG. 1 Wire saw according to the invention on a telescopic loader,

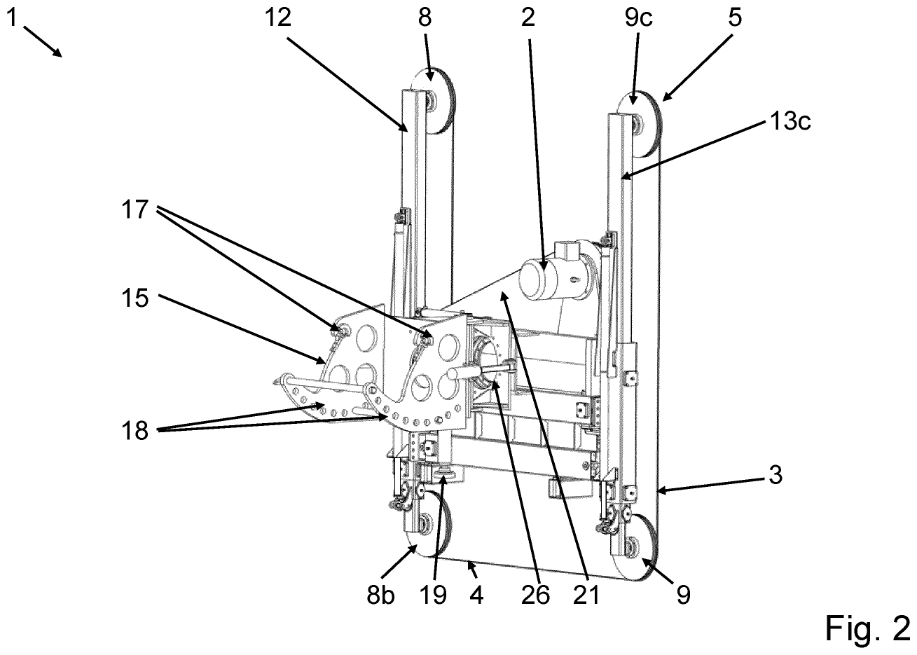

FIG. 2 Rear view of the wire saw,

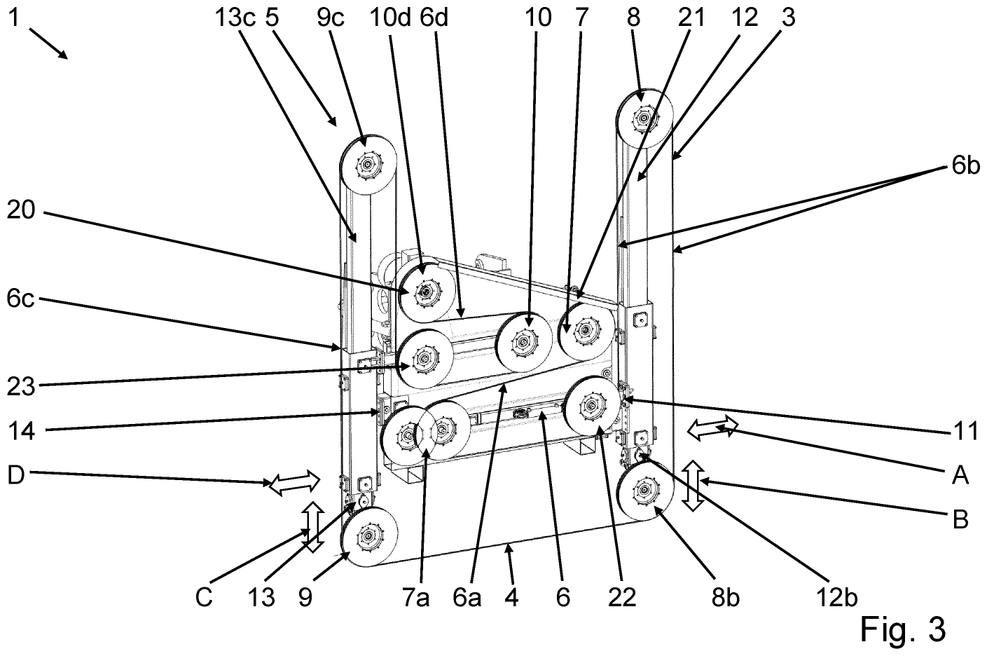

FIG. 3 front view of the wire saw,

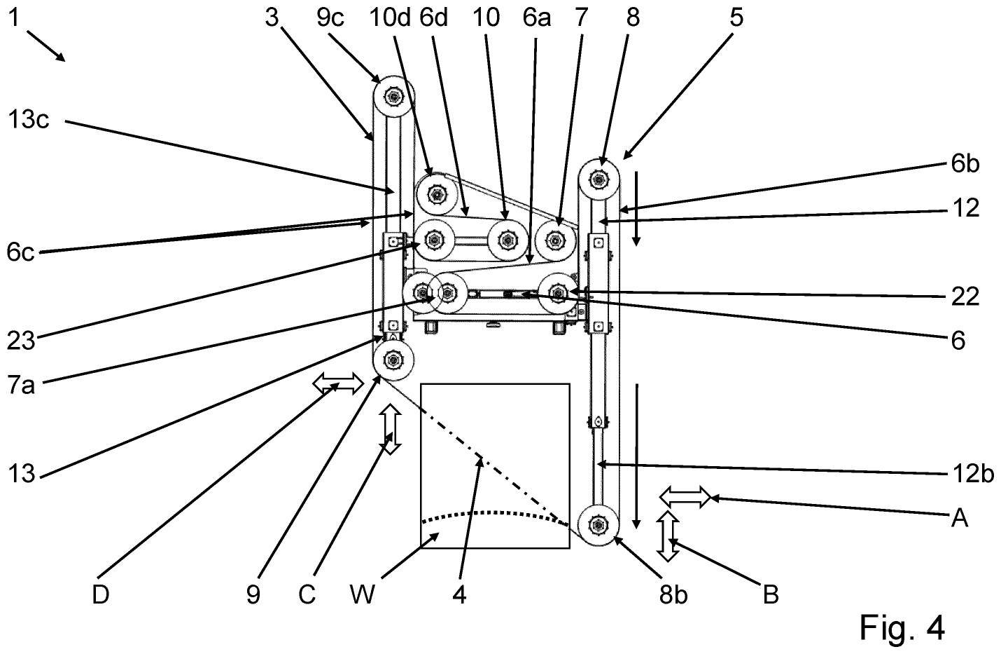

FIG. 4 one-sided infeed of the sawing section,

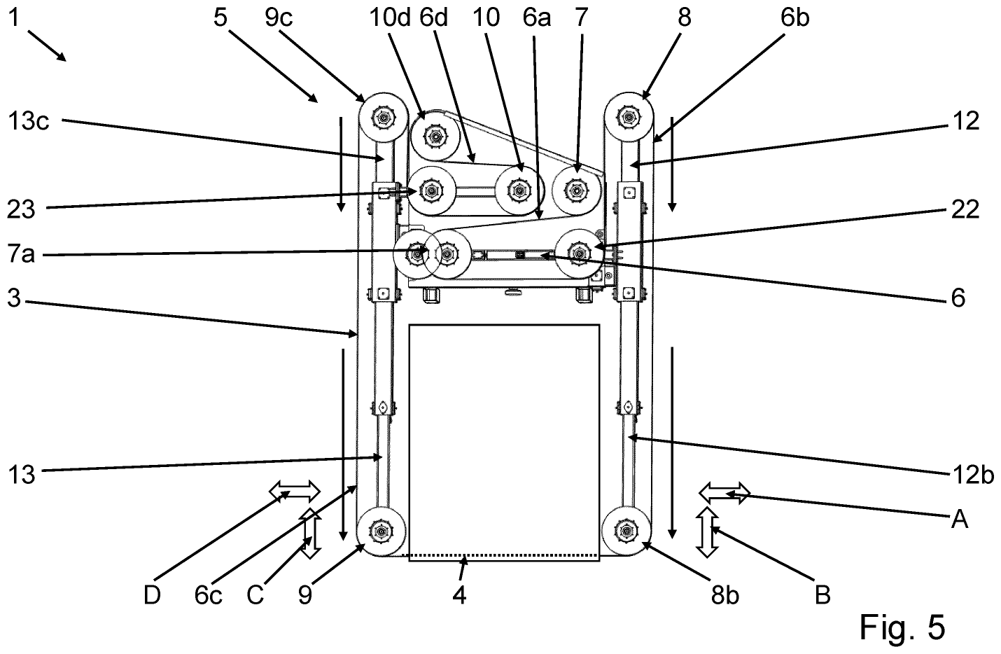

FIG. 5 feed of the sawing section on both sides,

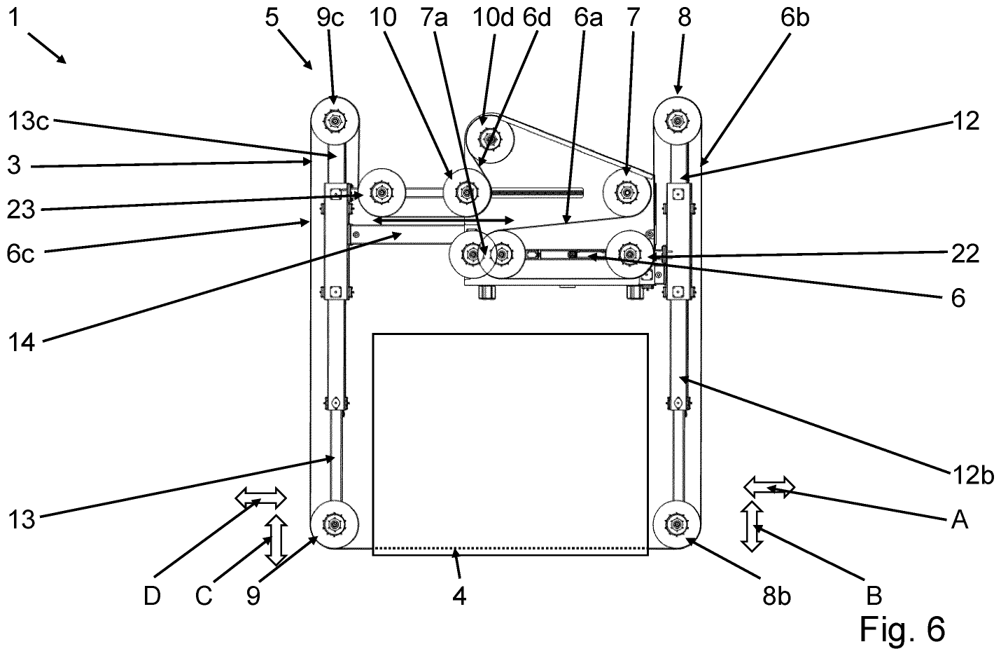

FIG. 6 one-sided extension of the sawing section,

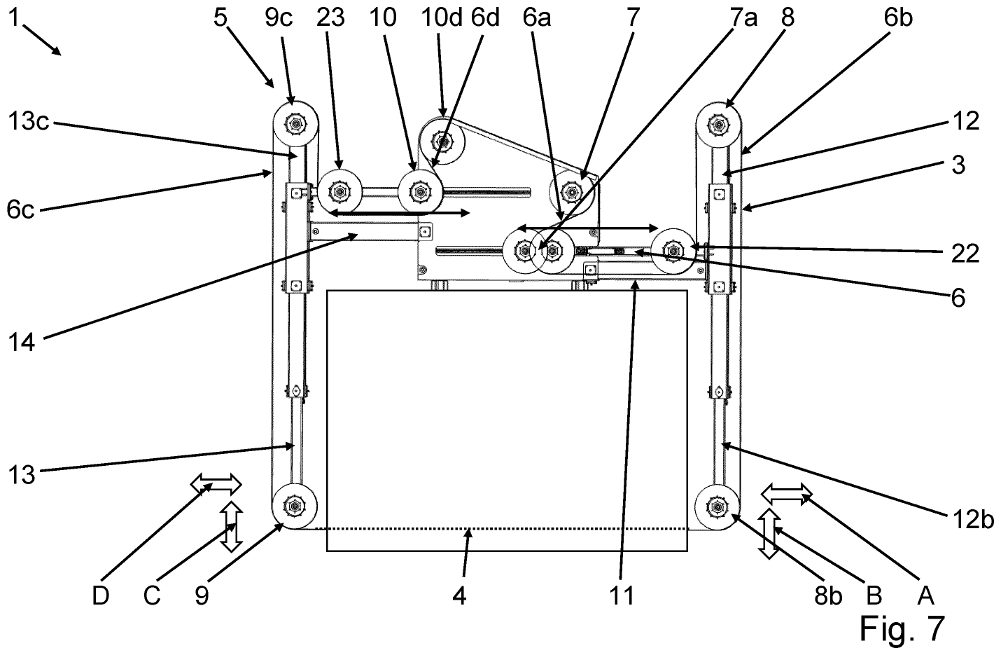

FIG. 7 extension of the sawing section on both sides,

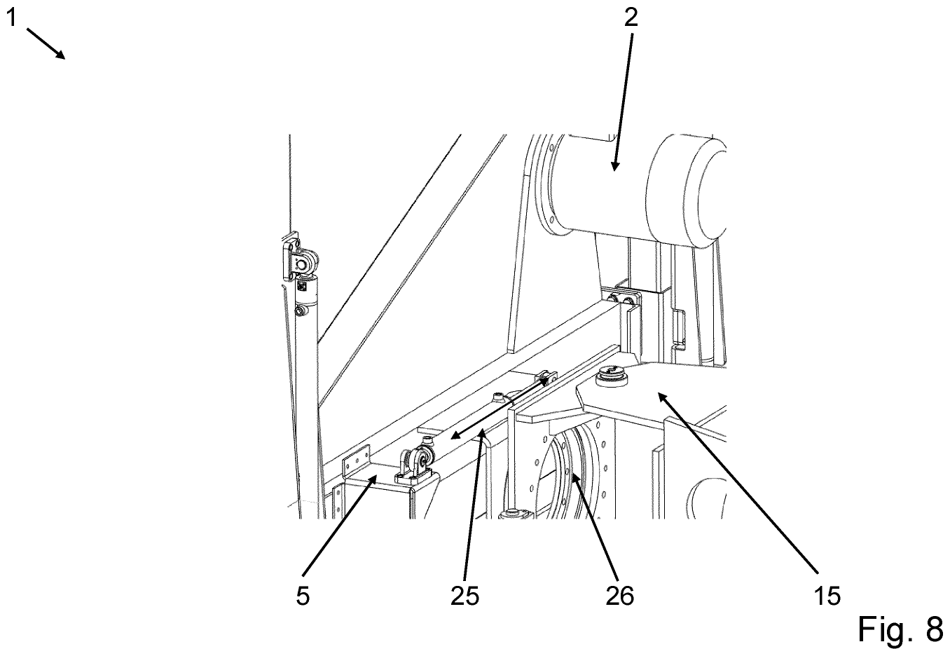

FIG. 8 detailed view of the swiveling device,

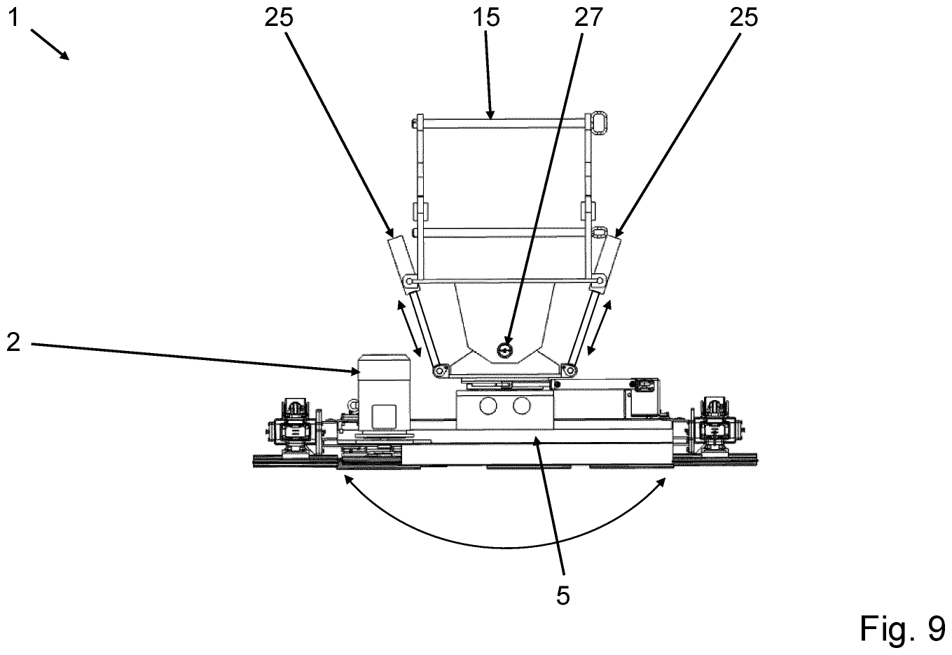

FIG. 9 View of the swiveling device,

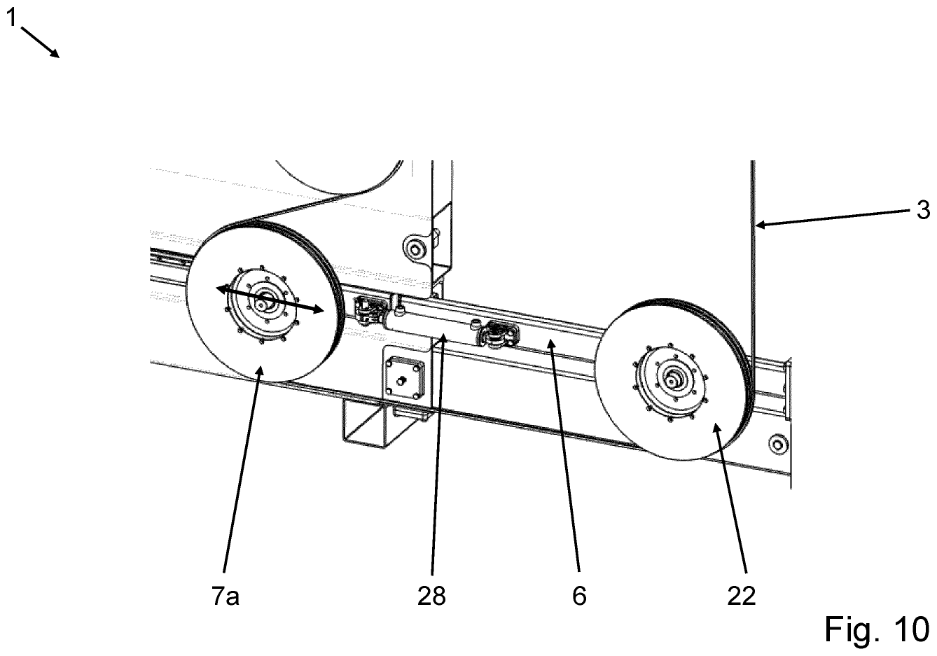

FIG. 10 Detail view of the wire storage and tensioning device,

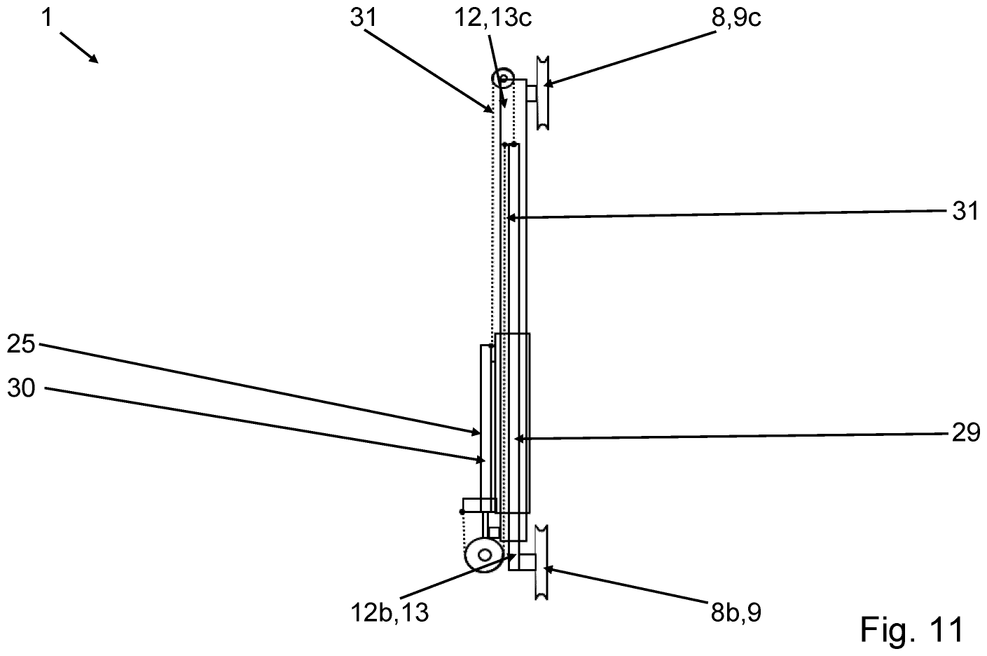

FIG. 11 side view of the retracted lower main telescopic extension,

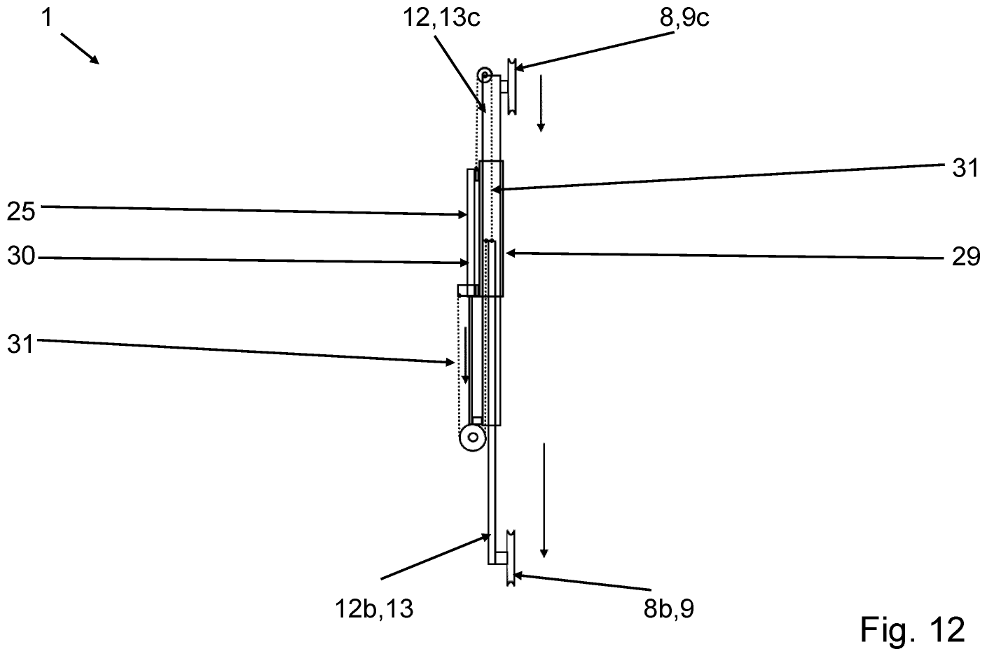

FIG. 12 side view of the extended lower main telescopic extension and

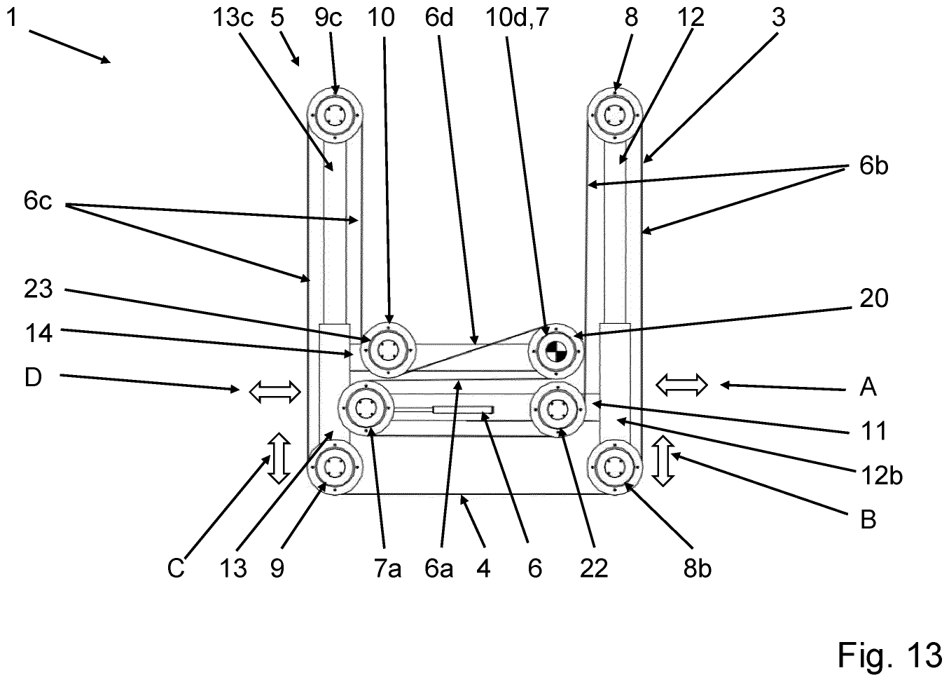

FIG. 13 Front view of a variant of the wire saw.

A wire saw according to the invention is shown in FIG. 1 with the reference sign 1. Here, the wire saw 1 is attached to a telescopic loader 16 via a changing device 15. For this purpose, it is provided that the wire saw 1 has a changing device 15 for attachment to a mobile carrier device 16 such as the telescopic loader. Within the scope of the invention, the mobile carrier device 16 can be attached to a carrier vehicle, in particular a driven utility vehicle, for example a wheeled excavator, a tracked excavator, a wheeled loader, a tractor with front loader or the like and precisely a telescopic loader, via the changing device 15, depending on the area of application. Thus, it is achieved that the mobile wire saw 1 can be transported to the place of use, e.g. also to exposed stones, whereby the workpieces W can be cut up on site. A time-consuming and cost-intensive transport of the workpieces W towards the wire saw 1 is thus no longer necessary. The time required to finish cutting the workpiece W is substantially reduced. Since the wire saw 1 according to the invention can be used in a mobile manner on a carrier device 16, it is further achieved that it is no longer necessary to guide the workpiece W towards the saw wire 3, in particular to lift it, but that the saw wire 3 can now be guided towards the workpiece W. In FIG. 2, the wire saw 1 according to the invention is shown obliquely from the rear. In this perspective view, the changing device 15 can be clearly seen, by means of which the wire saw 1 can be coupled to the carrier device 16 (FIG. 1). The changeover device 15 has a mounting 17 and a perforated plate 18 to enable the wire saw 1 to be mounted tilted in steps relative to the carrier device 16. In addition, a stand 19 can be seen in the rear view, via which the wire saw 1 can be placed on the ground or on a workpiece W to be cut (FIG. 1). With the support of the wire saw 1 on the workpiece W to be divided (FIG. 1), the load on the carrier device 16 can be relieved during the dividing process. Also shown in this illustration is the drive 2 of the wire saw 1, by means of which the saw wire 3 is driven for cutting the workpiece W (FIG. 1). The drive 2 can be a purely hydraulic, a purely electric or an electrohydraulic drive 2 and could drive any of the deflection pulleys.

FIG. 3 shows the wire saw 1 according to FIGS. 1 and 2 in a front view obliquely from the front. In this illustration, the guidance of the saw wire 3 driven by the drive 2 through the entire guiding device 5 can be seen. The drive 2 is coupled to a drive pulley 20 for transmitting the drive rotation to the saw wire 3, which converts the rotary movement of the drive 2 into a translatory movement of the saw wire 3. The saw wire 3 is guided under a protective cover 21 to a first deflection pulley 7. This deflection pulley 7 forms with the next deflection pulley 7a a first pair of deflection pulleys 7, 7a, which serves as a first wire storage 6a.

After this wire storage 6a, the saw wire 3 is deflected via a further deflection pulley 22, towards a second pair of deflection pulleys 8, 8b, which forms a second wire storage 6b. While the first wire storage 6a is assigned to the lateral direction of movement A of the second pair of deflection pulleys 8, 8b, as will be explained in more detail later, the second pair of deflection pulleys 8, 8b forms the second wire storage 6b for the infeed of the lower deflection pulley 8b and the subsequent sawing section 4 in the direction B and of the workpiece W to be cut, which is preferably located under the sawing section 4 during cutting, as shown in FIG. 1. The sawing section 4 formed by the saw wire 3 ends with the lower deflection pulley 9 of a third pair of deflection pulleys 9, 9c, which forms the third wire storage 6c. This third wire storage 6c is also associated with the infeed of the sawing section 4 in the direction of the workpiece W to be cut. Downstream of the third wire storage 6c, a further deflection pulley 23 is provided which deflects the saw wire 3 to a fourth pair of deflection pulleys 10, 10d of the guiding device 5, this fourth pair of deflection pulleys 10, 10d forming a fourth wire storage 6d. This fourth wire storage 6d comprises as deflection pulley 10d the drive pulley 20 coupled to the drive 2 and is associated with the lateral direction of movement C of the third deflection pulley pair 9, 9c, as will be explained in more detail later. A wire tensioning device 6 is also provided on the first pair of deflection pulleys 7, 7a, which ensures sufficient wire tension of the saw wire 3 in the guiding device 5 and, among other things, also compensates for extensions of the wire 3 due to temperature or wear during the cutting of the workpieces W (FIG. 1). During the cutting of a workpiece W (FIG. 1), the sawing section 4 formed between the lower deflection pulleys 8b, 9 engages the workpiece W (FIG. 1) to be cut. For this purpose, the saw wire 3 is preferably provided with diamond segments which cut into the workpiece material during the cutting of the concrete or stone block. Via the shown guiding device 5, the saw wire 3 can be guided in the wire saw 1 and the sawing section 4 formed by the saw wire 3 can be easily positioned with respect to the workpiece W. For this purpose, the guiding device 5 allows several independent directions of movement A, B, C, D, so that, in addition to an infeed of the sawing section 4 in the direction of the workpiece W to be cut, at least by the vertical displacement of the lower deflection pulleys 8b, 9, a change in the length of the sawing section 4 is also possible at the same time, at least by the horizontal displacement of the lower deflection pulleys 8b, 9. A special feature of the wire saw 1 shown here is that the guiding device 5 has for each of the directions of movement A, B, C, D a separate wire storage 6a, 6b, 6c, 6d associated with the individual direction of movement A, B, C, D.

Thus, the first wire storage 6a is assigned to the lateral or horizontal direction of movement A of the second pair of deflection pulleys 8, 8b and, as can also be seen in FIG. 7, enables the second pair of deflection pulleys 8, 8b to be displaced laterally or horizontally. With the displacement of the lower deflection pulley 8b of the second pair of deflection pulleys 8, 8b to the outside, the sawing section 4 formed by the saw wire 3 is enlarged, as can be seen in FIG. 7. The saw wire 3 required for the lateral extension of the sawing section 4 is released from the first wire storage 6a when the second pair of deflection pulleys 8, 8b is moved in the first direction of movement A. If the second pair of deflection pulleys 8, 8b is moved inward again in the first direction of movement A, as can be seen in FIG. 3, the first wire storage 6a can receive the saw wire 3 again. For this purpose, the distance of the deflection pulleys 7, 7a of the pair of deflection pulleys 7, 7a forming the first wire storage 6a is changed synchronously with the displacement of the second pair of deflection pulleys 8, 8b. For release from the saw wire 3, the distance between the deflection pulleys 7, 7a of the first wire storage 6a is shortened, as can be seen in FIG. 7, in order to release wire length stored for a corresponding lengthening of the sawing section 4 from the first wire storage 6a. When the sawing section 4 is shortened, the distance of the deflection pulleys 7, 7a of the first wire storage 6a is increased again in order to store the saw wire 3 in the first wire storage 6a according to the shortening. The change in the distance of the deflection pulleys 7, 7a combined in pairs to form the first wire storage 6a is achieved by the second deflection pulley 7a being arranged on a first telescopic extension 11, via which the pulley distance of the pair of deflection pulleys 7, 7a in the first wire storage 6a can be changed.

The second wire storage 6b is assigned to a vertical direction of movement B for the infeed of the sawing section 4 in the direction of the workpiece W to be cut (FIG. 1) and, as can also be seen in FIGS. 4 and 5, enables a vertical displacement of the lower deflection pulley 8b of the second pair of deflection pulleys 8, 8b. As a result, the sawing section 4 is guided on the right side in the direction of the workpiece W to be cut, as can be seen in FIGS. 4 and 5. With the displacement of the lower deflection pulley 8b of the second pair of deflection pulleys 8, 8b downward, the sawing section 4 formed by the saw wire 3 is guided downward or through the workpiece W to be divided, as can be seen in FIGS. 4 and 5. The saw wire 3 required for feeding the sawing section 4 is released from the second wire storage 6b when the lower deflection pulley 8b of the second pair of deflection pulleys 8, 8b is moved in the second direction of movement B. If the lower deflection pulley 8b of the second pair of deflection pulleys 8, 8b is moved upwards again in the second direction of movement B, as can be seen in FIG. 3, the second wire storage device 6b can receive the saw wire 3 again. For this purpose, the distance between the deflection pulleys 8, 8b of the pair of deflection pulleys 8, 8b forming the second wire storage 6b is changed. To release saw wire 3, the position and distance of the deflection pulleys 8, 8b of the second wire storage 6b is changed, as shown in FIGS. 4 and 5, in order to release correspondingly stored wire length from the second wire storage 6b for the infeed of the sawing section 4. When the sawing section 4 is fed in the direction of the workpiece W to be cut, the lower deflection pulley 8b is moved downward in accordance with the feed via the first main telescopic extension 12, 12b. This first main telescopic extension 12, 12b is designed as a double telescopic extension 12, 12b with a two-part telescopic extension 12, 12b in opposite directions. As a result, the distance between the upper deflection pulley 8 of the second wire storage 6b is reduced by the second telescopic extension 12 to the further deflection pulley 22 by half of the infeed at the same time as the lower deflection pulley 8b is advanced by the telescopic extension 12b. This releases the saw wire length stored in the second wire storage unit 6b. When the sawing section 4 is moved back, the distance of the deflection pulleys 8, 8b of the second wire storage 6b is changed again by increasing the distance of the further deflection pulley 22 to the upper deflection pulley 8 of the second wire storage 6b by half of the return of the lower deflection pulley 8b in order to store the saw wire 3 in the second wire storage 6b according to the return. The change of the distance of the deflection pulleys 8, 8b combined in pairs to the second wire storage 6b is achieved by the fact that the two deflection pulleys 8, 8b are arranged at the second telescopic extension 12, 12b, which as a double telescopic extension 12, 12b changes the distance of the deflection pulleys 8, 8b by changing the position of both deflection pulleys 8, 8b.

The third wire storage 6c is also assigned to a vertical direction of movement C for the infeed of the sawing section 4 in the direction of the workpiece W to be cut and, as can also be seen in FIG. 5, enables a vertical displacement of the lower deflection pulley 9 of the third pair of deflection pulleys 9, 9c, which forms the third wire storage 6c. As a result, the sawing section 4 is guided on the left side in the direction of the workpiece W to be cut, as can be seen in FIG. 5. By displacing the lower deflection pulley 9 of the third pair of deflection pulleys 9, 9c downward, the sawing section 4 formed by the saw wire 3 is guided downward or through the workpiece W to be divided, as can be seen in FIG. 5. The saw wire 3 required for the infeed of the sawing section 4 is released by the third wire storage 6c when the lower deflection pulley 9 of the third pair of deflection pulleys 9, 9c is moved in the third direction of movement C. The third wire storage 6c is used for the movement of the lower deflection pulley 9 of the third pair of deflection pulleys 9, 9c. When the lower deflection pulley 9 of the third pair of deflection pulleys 9, 9c is moved upwards again in the third direction of movement C, as shown in FIG. 3, the third wire storage device 6c can take up the saw wire 3 again. For this purpose, the distance between the deflection pulleys 9, 9c of the pair of deflection pulleys 9, 9c forming the third wire storage 6c is changed.

To release saw wire 3, the position and the distance of the deflection pulleys 9, 9c of the third wire storage 6c is changed, as shown in FIG. 5, in order to release correspondingly stored wire length from the third wire storage 6c for the infeed of the sawing section 4. When the sawing section 4 is fed in the direction of the workpiece W to be cut, the lower deflection pulley 9 is moved downward in accordance with the feed via the second main telescopic extension 13, 13c. This second main telescopic extension 13, 13c is designed as a double telescopic extension 13, 13c with a two-part telescopic extension 13, 13c in opposite directions. Hereby, at the same time as the lower deflection pulley 9 is advanced, the distance between the upper deflection pulley 9c of the third wire storage 6c through the third telescopic extension 13, 13c and the following further deflection pulley 23 is reduced by half of the advance. This releases the saw wire length stored in the third wire storage unit 6c. When the sawing section 4 is moved back, the distance of the deflection pulleys 9, 9c of the third wire storage 6c is changed again by increasing the distance of the further deflection pulley 23 to the upper deflection pulley 9c of the third wire storage 6c by half of the return of the lower deflection pulley 9 in order to store the saw wire 3 in the third wire storage 6c according to the return. The change in the distance of the deflection pulleys 9, 9c combined in pairs to form the third wire storage 6c is achieved by the two deflection pulleys 9, 9c being arranged on the third telescopic extension 13, 13c, which forms the second main telescopic extension 13, 13c and, as a double telescopic extension 13, 13c, changes the distance of the deflection pulleys 9, 9c by changing the position of both deflection pulleys 9, 9c.

The fourth wire storage 6d is associated with the lateral or horizontal direction of movement D of the third pair of deflection pulleys 9, 9c and, as can also be seen in FIGS. 6 and 7, enables the third pair of deflection pulleys 9, 9c to be displaced laterally or horizontally. With the displacement of the lower deflection pulley 9 of the third pair of deflection pulleys 9, 9c to the outside, the sawing section 4 formed by the saw wire 3 is enlarged, as can be seen in FIGS. 6 and 7. The saw wire 3 required for the lateral extension of the sawing section 4 is released from the fourth wire storage 6d when the third pair of deflection pulleys 9, 9c is moved in the fourth direction of movement D. If the third pair of deflection pulleys 9, 9c is moved inward again in the fourth direction of movement D, as can be seen in FIG. 3, the fourth wire storage device 6d can receive the saw wire 3 again. For this purpose, the distance of the deflection pulleys 10, 10d of the pair of deflection pulleys 10, 10d forming the fourth wire storage 6d is changed by shifting the deflection pulleys 10, 23 in the same direction as the lateral shifting of the third pair of deflection pulleys 9, 9c. To release saw wire 3, the distance between the deflection pulleys 10, 10d of the fourth wire storage 6d is shortened, as shown in FIGS. 6 and 7, in order to release wire length stored for a corresponding lengthening of the sawing section 4 from the fourth wire storage 6d. When the sawing section 4 is shortened, the distance of the deflection pulleys 10, 10d of the fourth wire storage 6d is increased again in order to store the saw wire 3 in the fourth wire storage 6d according to the shortening. The change of the distance of the deflection pulleys 10, 10d combined in pairs to form the fourth wire storage 6d is achieved by the fact that the first deflection pulley 10 is arranged on a fourth telescopic extension 14, by means of which the pulley distance of the pair of deflection pulleys 10, 10d in the fourth wire storage 6d can be changed.

FIG. 4 shows the one-sided infeed of the sawing section 4 into the workpiece W. The right main telescopic extension 12, 12b has here been actuated independently of the left main telescopic extension 13, 13c for feeding the sawing section 4 in the direction of the workpiece W to be cut. The right upper deflection pulley 8 has been moved downward only by half the feed of the lower deflection pulley 8b of the second wire storage 6b. Thus, wire storage in the second wire storage device 6b takes place via the telescoping of the second telescopic extension 12, 12b in the ratio 1:2. With the double telescope 12, 12b of the first main telescopic extension 12, 12b via which both deflection pulleys 8, 8b of the second wire storage device 6b can be moved, wire storage thus takes place in the ratio 1:2. The distance between the two deflection pulleys 8, 8b of the second wire storage device 6b is not constant but can be flexibly adjusted via the double telescope 12, 12b. The one-sided infeed of the sawing section 4 shown in FIG. 4 has the advantage that the saw wire 3 does not always have to be driven equally on the left and right through a workpiece W, which, depending on the application, leads to a lower load on the saw wire or can accelerate the sawing process.

FIG. 5, on the other hand, shows a two-sided infeed of the sawing section 4 by the two main telescopic extensions 12, 12b, 13, 13c. For this purpose, the main telescopic extensions 12, 12b, 13, 13c position the deflection pulleys 8, 8b, 9, 9c, which are combined in pairs to form the wire storage 6b, 6c, by changing the extension position in order to achieve an infeed of the sawing section 4 in the direction of the workpiece W to be cut. The figure shows that separate wire storages 6b, 6c are formed at both main telescopic extensions 12, 12b, 13, 13c in order to release stored saw wire 3 for the completed movements of the guiding device 5 when the lower deflection pulleys 8b, 9 or the sawing section 4 formed therebetween are advanced in the direction of the workpiece W to be cut. Due to the fact that the two upper telescopic extensions 12, 13c and the two lower telescopic extensions 12b, 13 of the double telescopes 12, 12b, 13, 13c move downward in the ratio 50/100, the total wire length of the saw wire 3 as well as the width of the formed sawing section 4 remains unchanged during the infeed.

FIG. 6 shows a one-sided extension of the sawing section 4 on the wire saw 1. For this purpose, the fourth wire storage 6d, which is assigned to the lateral or horizontal direction of movement D of the second main telescopic extension 13, 13c, releases the required saw wire 3. Hereby, the fourth wire storage 6d enables a lateral or horizontal displacement of the third pair of deflection pulleys 9, 9c together with the third telescopic extension 13, 13c. With the displacement of the lower deflection pulley 9 of the third pair of deflection pulleys 9, 9c to the outside, the sawing section 4 formed by the saw wire 3 is enlarged. The saw wire 3 required for the lateral extension of the sawing section 4 is released from the fourth wire storage 6d when the third pair of deflection pulleys 9, 9c is moved in the fourth direction of movement D. If the third pair of deflection pulleys 9, 9c together with the double telescopic extension 13, 13c are moved inwards again in the fourth direction of movement D, as can be seen in FIG. 3, the fourth wire storage 6d can receive the saw wire 3 again. For this purpose, the distance between the deflection pulleys 10, 10d of the pair of deflection pulleys 10, 10d forming the fourth wire storage 6d is changed. To release saw wire 3, the distance between the deflection pulleys 10, 10d of the fourth wire storage 6d is shortened, as can also be seen in FIG. 7, in order to release wire length stored for a corresponding lengthening of sawing section 4 from the fourth wire storage 6d. When the sawing section 4 is shortened, the distance of the deflection pulleys 10, 10d of the fourth wire storage 6d is increased again in order to store the saw wire 3 in the fourth wire storage 6d according to the shortening. The change of the distance of the deflection pulleys 10, 10d combined in pairs to form the fourth wire storage 6d is achieved by the fact that the first deflection pulley 10 is arranged on a fourth telescopic extension 14, via which the pulley distance of the pair of deflection pulleys 10, 10d in the fourth wire storage 6d can be changed. Thus, when the sawing section 4 is lengthened and shortened, the wire length compensation takes place via the horizontal wire storage in the first 6a and the fourth wire storage 6d. The horizontal wire length compensation in the two wire storages 6a, 6d takes place in a ratio of 1:1. Another special feature of the arrangement shown of the deflection pulleys 7, 7a, 8, 8b, 9, 9c, 10, 10d in the guiding device 5 is that a total of four deflection pulleys 7a, 22, 8, 8b and 9, 9c, 23, 10 in each case are located on the laterally displaceable extensions. Two of the deflection pulleys 23, 10 have a constant distance in the horizontal for the function of the side extension. The wire tensioning device 6 is arranged on the other side extension, so that the distance between the two deflection pulleys 7a, 22 on the extension is variable. The drive pulley 20 is fixed to the machine frame and coupled to the drive 2.

FIG. 7 shows the extension of the sawing section 4 on both sides by changing the distance between the two main telescopic extensions 12, 12b, 13, 13c. These two double telescopic extensions 12, 12b, 13, 13c are moved apart laterally to the workpiece W to be cut via the first 11 and the fourth telescopic extension 14. In this way, a compact transport size can be realized with the telescopic extensions 11, 12, 12b, 13, 13c, 14 retracted, while, as can be seen in FIG. 7, with the main telescopic extensions 12, 12b, 13, 13c moved outwards on both sides, a wide sawing section 4 can be created between the lower deflection pulleys 8b, 9.

FIG. 8 shows a detailed view of the rotating device 24, which can also be seen in FIG. 2, by means of which the guiding device 5 can be rotated about the changeover device 15. For this purpose, a working cylinder 25 is provided which enables a rotary movement between the guiding device 5 and the changeover device 15 about the rotary joint 26 formed here. This allows the guiding device 5 to be aligned before the cutting operation and also to be rotated on the changeover device 15 during operation.

FIG. 9 shows a view of the swivel device 27 between the changeover device 15 and the guiding device 5, by means of which the guiding device 5 can be swiveled relative to the changeover device 15. For this purpose, working cylinders 25 are provided which initiate the swiveling movement between the changeover device 15 and the guiding device 5. In this way, the guiding device 5 can already be aligned before the cutting process and can also be swiveled at the changeover device 15 during operation.

FIG. 10 is a detailed view of the wire storage and wire tensioning device 6, which has a tensioning cylinder 28 that moves the deflection pulley 7a used as a tensioning pulley. The tensioning cylinder 28, which is preferably designed as a hydraulic cylinder, is pressurized during sawing in order to keep the wire tension constant. This is done according to the operating principle of a spring. The pressure in the tensioning cylinder 28 is relatively constant, however, it is not the pressure that is controlled, but the output signal of, for example, a measuring pin that connects the lugs to the eye of the cylinder 28. If, as shown in FIG. 4, only one main telescopic extension 12, 12b is extended, the tensioning cylinder 28 automatically provides for the wire length compensation by means of the pressure control via the displacement of the tensioning pulley 7a. When the saw wire 3 is laid on, the tensioning cylinder 28 is retracted in order to be able to lay the wire 3 without tension on the deflection pulleys 7, 7a, 8, 8b, 9, 9c, 10, 10d 22, 23 of the guiding device 5.

The wire tensioning device 6 with the deflection pulley 7a serves the additional purpose of compensating for wire length changes which result, for example, from the diagonal alignment of the sawing section 4, as shown in FIG. 4, and which cannot be compensated for by the wire storages 6a, 6b, 6c, 6d.

FIG. 11 shows a side view of a retracted lower main telescopic extension 12, 12b, 13, 13c. The main telescopic extensions 12, 12b, 13, 13c each have a working cylinder 25 via which the double telescopic extension 12, 12b, 13, 13c can be extended. The extension box 29 is firmly connected to the working cylinder housing 30. The upper telescopic extension 12, 13c is connected to the upper deflection pulley 8, 9c, and the piston rod of the working cylinder 25. The working cylinder 25 adjusts the height of the upper telescopic extension 12, 13c via the piston rod. The lower telescopic extension 12b, 13 is adjusted in its height via wire hoists 31 by the movement of the upper telescopic extension 12, 13c. The two wire hoists 31 are necessary to exert both traction and compression.

As can be seen in FIG. 12, pushing down the upper telescopic extension 12, 13c by means of the working cylinder 25 via the wire hoists causes the lower telescopic extension 12b, 13 to be pushed down by double. For example, when the sawing section 4 with a main telescopic extension is moved down by one meter, it is sufficient to move the upper pulley 8, 9c of the telescopic extension down by half a meter. This can be easily achieved by a controlled length change of the upper part of the three-part main telescopic extension 12, 12b, 13, 13c, 29. The length change of the main telescopic extension 12, 12b, 13, 13c upwards and downwards can be achieved, for example, by means of working cylinders. Telescoping can also be achieved by means of two hydraulic cylinders or a telescoping hydraulic cylinder, an electric linear drive, a rack and pinion drive, a jack screw drive with a trapezoidal screw or the like. In the case of the one-meter change in sawing depth suggested as an example above, a very long hydraulic cylinder would have to be provided to extend the lower extension 12b, 13 accordingly. In addition, another hydraulic cylinder would be required to retract the upper telescopic extension 12, 13c by half a meter. Therefore, the design shown in FIGS. 11 and 12 provides a strong simplification by using only one working cylinder 25 for each double telescopic extension 12, 12b, 13, 13c, which first operates the upper telescopic extension 12, 13c, respectively. The necessary double length change of the lower telescopic extension 12b, 13 is solved by a system with two wire hoists 31—or chain hoists with two pulleys on the upper telescopic extension 12, 13c, which couples the lower telescopic extension 12b, 13 with the upper telescopic extension 12, 13c.

The proposed wire saw 1 has the advantage that the wire storage is divided among several wire storage units 6a, 6b, 6c, 6d. For the wire storage when the width of the sawing section 4 is changed, two deflection pulleys 7, 7a, 10, 10d are provided twice to compensate for the change in length of the saw wire 3 when the distance between the main telescopic extensions 12, 12b, 13, 13c is changed. In this case, the deflection pulleys 7a, 22 and 10, 23 are each moved along with the main telescopic extensions 12, 12b, 13, 13c by means of the first and fourth telescopic extensions 11, 14, respectively.

For the change of the infeed of the saw wire 3, which is adjusted by the change of the length or height of the lateral telescopic extensions, the wire storage is provided in the telescopic extensions 12, 12b, 13, 13c themselves. The telescopic extensions 12, 12b, 13, 13c are thus not only used to change the infeed of the saw wire, but are also used as wire storage 6b, 6c via a controlled length change of the double telescopic extensions 12, 12b, 13, 13c upwards and downwards in conjunction with two further deflection pulleys 8, 9c arranged at the upper end of the telescopic extensions.

In a wire saw 1 it is advantageous to keep the number of deflections of the guiding device 5 as low as possible, because each deflection contributes to the wear of the saw wire 3. In this sense, FIG. 13 shows a variant of the wire saw 1 according to the invention in which the guiding device 5 comprises only eight pulleys. In this variant, the telescopic extensions 11, 12, 12b, 13, 13c and 14 are practically identical to the wire saw 1 according to FIGS. 2-12.

In this variant, the drive pulley 20 additionally assumes the function of the deflection pulley 7 of the wire saw 1 shown in FIGS. 2-12. At the same time, the drive pulley 20 remains an element of the wire storage device 6d as a deflection pulley 10d. As a result of the fact that in this variant the saw wire 3 is guided diagonally from the deflection pulley 10 to the deflection pulley 10d, two deflection pulleys are omitted compared to the wire saw 1 shown in FIGS. 2-12 and the number of deflections of the circulating saw wire is reduced by 20%, which results in a corresponding reduction in wear of the saw wire 3.

### LIST OF REFERENCE SIGNS

1 wire saw

2 drive

3 saw wire

4 sawing section

5 guiding device

6 wire tensioning device, 6a, 6b, 6c, 6d wire storage

7 7a first pair of deflection pulleys

8 8b second pair of deflection pulleys

9 9c third pair of deflection pulleys

10 10d fourth pair of deflection pulleys

11 first telescopic extension

12 12b second telescopic extension

13 13c third telescopic extension

14 fourth telescopic extension

15 changing device

16 telescopic loader

17 mounting

18 perforated plate

19 pedestal

20 drive pulley

21 protective cover

22 further deflection pulley

23 further deflection pulley

24 rotating device

25 working cylinder (hydraulic cylinder, pneumatic cylinder)

26 rotary joint

27 swivel device

28 tensioning cylinder

29 extension box

30 working cylinder housing

31 wire hoists

W workpiece

A first direction of movement

B second direction of movement

C third direction of movement

D fourth direction of movement

1-9. (canceled)

10. A wire saw comprising:
a saw wire arranged to be driven by a drive, the saw wire forming a sawing section for engagement with a workpiece to be cut;
a guide arranged to position the sawing section of the saw wire relative to the workpiece, the guide configured to permit a plurality of independent directions of movement such that, in addition to an advance of the sawing section in the direction of the workpiece to be cut, the sawing section can be lengthened and/or shortened; and
a wire-storage-and-tensioning device arranged for loading, unloading, and tensioning the saw wire when a position and/or a length of the sawing section is changed by the guide,
wherein the guide has, for each of the plurality of independent directions of movement, a separate wire storage associated with the given individual direction of movement.

11. The wire saw of claim 10, wherein the separate wire storage is formed by at least one pair of deflection pulleys.

12. The wire saw of claim 11, wherein the at least one pair of deflection pulleys is formed by increasing and decreasing a deflection pulley distance of the wire storage when the position and/or length of the sawing section stores or releases the saw wire.

13. The wire saw of claim 11, wherein the deflection pulley distance can be changed via telescopic extensions on which at least one of the pair of deflection pulleys is arranged.

14. The wire saw of claim 11, wherein the deflection pulley distance can be changed via telescopic extensions on which both of the at least one pair of deflection pulleys are arranged.

15. The wire saw of claim 10, wherein the guide has two main telescopic extensions configured to feed the sawing section in a direction of the workpiece to be cut.

16. The wire saw of claim 15, wherein the main telescopic extensions have deflection pulleys combined in pairs to form the wire storage and whose extension position can be varied on both sides via the main telescopic extensions in order to feed the sawing section in the direction of the workpiece to be cut.

17. The wire saw of claim 15, wherein a distance between the main telescopic extensions is variable in order to change a length of the sawing section.

18. The wire saw of claim 15, wherein the main telescopic extensions are movable independently of each other.
